(19) United States
(12) Patent Application Publication
(10) Pub. No.: US 2014/0204925 A1
(43) Pub. Date: Jul. 24, 2014

(54) INFORMATION PROVIDING SYSTEM, INFORMATION PROVIDING APPARATUS, AND INFORMATION PROVIDING METHOD

(71) Applicant: YAHOO JAPAN CORPORATION, Tokyo (JP)

(72) Inventor: Naomi OTOMO, Tokyo (JP)

(73) Assignee: YAHOO JAPAN CORPORATION, Tokyo (JP)

(21) Appl. No.: 14/152,435

(22) Filed: Jan. 10, 2014

(30) Foreign Application Priority Data
Jan. 23, 2013 (JP) 2013-010636

(51) Int. Cl. H04W 68/00; H04W 84/12

(52) U.S. Cl. CPC H04W 68/00; H04W 84/12
USPC 370/338

(57) ABSTRACT

An information providing system according to an embodiment includes a wireless LAN communication unit, a notification information storage unit, a terminal position acquisition unit, and a notification unit. The notification information storage unit stores notification information corresponding to the wireless LAN communication unit. The terminal position acquisition unit acquires position information indicating a position of a wireless terminal. The notification unit notifies a wireless terminal positioned in a communication area of the wireless LAN communication unit and not communicating with the wireless LAN communication unit of the notification information via a wireless WAN base station.

### CROSS-REFERENCE TO RELATED APPLICATIONS

The present application claims priority to and incorporates by reference the entire contents of Japanese Patent Application No. 2013-010636 filed in Japan on Jan. 23, 2013.

### BACKGROUND OF THE INVENTION

1. Field of the Invention

The present invention is an information providing system, an information providing apparatus, and an information providing method.

2. Description of the Related Art

In recent years, a wireless local area network (LAN) communication has rapidly spread. Wireless LAN access points are installed in various places such as stations, airports, and stores, and a wireless LAN communication function has been equipped with various mobile apparatuses such as personal computers, mobile phone apparatuses, and portable game apparatuses as a standard function. Such wireless LAN communication is expected to further spread, and users of the mobile apparatuses that are wireless terminals are expected to be able to use a connection environment to the fast Internet in more various locations.

An exhibition information distribution system in which a wireless LAN apparatus is installed in each exhibition area, and exhibition information corresponding to the exhibition area is transmitted from the wireless LAN apparatus to a wireless terminal in response to a request from the wireless terminal in such a communication environment has been proposed (for example, see Japanese Patent Application Laid-open No. 2012-39598).

However, the technology disclosed in Japanese Patent Application Laid-open No. 2012-39598 is realized on the assumption that the wireless LAN apparatus performs wireless LAN communication with the wireless terminal. When a wireless LAN function is in an OFF state in the wireless terminal, information providing via the wireless LAN apparatus to the wireless terminal cannot be performed.

### SUMMARY OF THE INVENTION

According to an exemplary embodiment, an information providing system includes a wireless LAN communication unit, a notification information storage unit, a terminal position acquisition unit, and a notification unit. The notification information storage unit stores notification information corresponding to the wireless LAN communication unit. The terminal position acquisition unit acquires position information indicating a position of a wireless terminal. The notification unit notifies a wireless terminal, which is positioned in a communication area of the wireless LAN communication unit and which is not performing communication with the wireless LAN communication unit, of the notification information via a wireless WAN base station.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1A is a diagram illustrating a configuration of an information providing system according to an embodiment;

FIG. 1B is an explanatory diagram of information providing process performed by the information providing system illustrated in FIG. 1A;

FIG. 2 is a diagram illustrating a specific configuration example of an information providing system according to a first embodiment;

FIGS. 3A and 3B are diagrams illustrating sequences of establishing sessions between a wireless LAN access point and a wireless terminal;

FIG. 4 is a diagram illustrating an example of an AP terminal information table stored in a location information DB;

FIG. 5 is a diagram illustrating an example of a terminal position information table stored in the location information DB;

FIG. 6 is a diagram illustrating an example of an AP location information table stored in the location information DB;

FIG. 7 is an example of a user information table stored in a user information DB;

FIGS. 8A to 8C are diagrams illustrating screen examples in which information provided from an information providing apparatus is displayed in a display unit of a wireless terminal;

FIG. 9 is a flowchart of information processing in a wireless LAN access point;

FIG. 10 is a flowchart of information processing in the information providing apparatus;

FIG. 11 is a flowchart of first notification processing illustrated in FIG. 10; and

FIG. 12 is a flowchart of second notification processing illustrated in FIG. 10.

### DETAILED DESCRIPTION OF THE PREFERRED EMBODIMENTS

Hereinafter, embodiments of an information providing system, an information providing apparatus, and an information providing method according to the present application will be described in detail with reference to the drawings. Note that the information providing system, the information providing apparatus, and the information providing method according to the present application are not limited by the embodiments.

1. Information Providing System

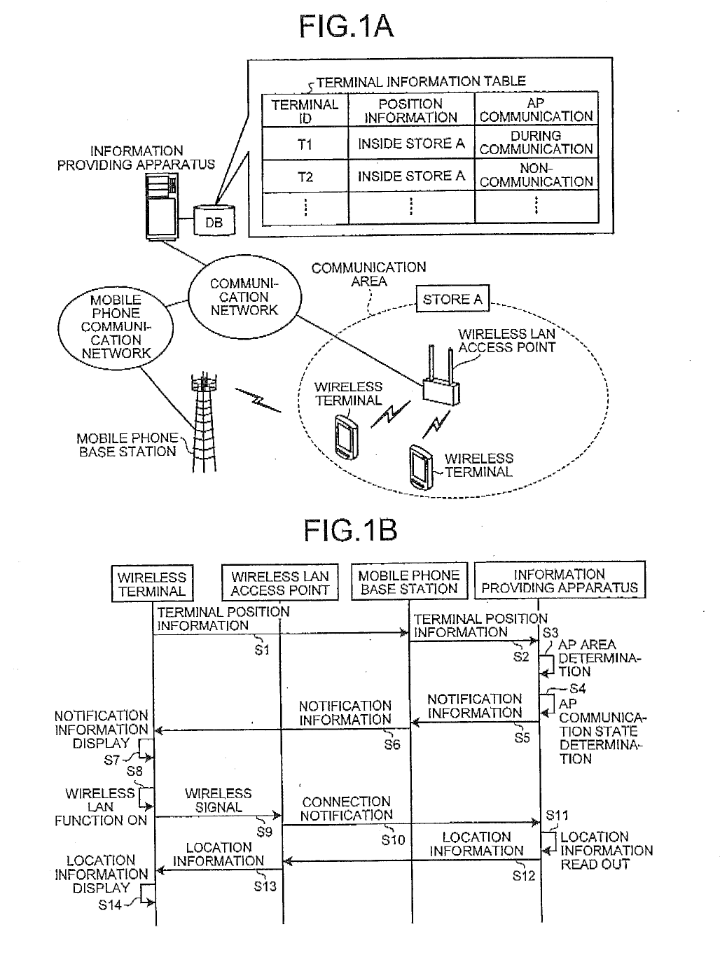

First, a configuration of an information providing system according to an embodiment will be described. FIG. 1A is a diagram illustrating a configuration of an information providing system of an embodiment.

As illustrated in FIG. 1A, an information providing system according to an embodiment includes a wireless local area network (LAN) access point and an information providing apparatus. The information providing apparatus can perform communication with a wireless LAN access point through a communication network, and can perform communication with a wireless terminal that is a mobile phone apparatus through the wireless LAN access point or a mobile phone communication network. The communication network is, for example, an Internet Protocol (IP) network such as the Internet.

The mobile phone communication network that is a wide area network (WAN) is connected to the communication network through a gateway server (not illustrated). The wireless terminal can access a server (for example, a website) connected to the communication network through a mobile phone base station (corresponding to an example of a wireless WAN base station) of the mobile phone communication network. Further, the wireless terminal is a mobile phone apparatus equipped with a wireless LAN communication function, and can access the server through a wireless LAN access point in a communication area of the wireless LAN access point.

Further, the wireless terminal includes a global positioning system (GPS) unit, and every time receiving a signal from a GPS satellite by the GPS unit, the wireless terminal calculates a current position on the basis of the received signal. The current position is, for example, a position indicated by the latitude and the longitude.

The wireless LAN access point includes a wireless LAN communication unit, and can mutually perform wireless communication with the wireless terminal by the wireless LAN communication unit. The wireless LAN access point covers, as a communication area, commercial spaces such as a station, a shopping street, and an event site where concerts and sports are performed, in addition to a store, a restaurant, a beauty salon, a barber, a hospital, a movie theater, and a complex leisure facility.

The information providing apparatus includes a database (hereinafter, described as DB) that stores notification information. The information providing apparatus selects notification information corresponding to a wireless LAN access point in which the wireless terminal exists from among the notification information stored in the DB, acquires the notification information from the DB, and transmits the notification information to the wireless terminal. The wireless terminal that is an object to be transmitted of the notification information is a wireless terminal in which the wireless LAN communication function is turned OFF, and the notification information is notified to the wireless terminal through the mobile phone base station.

The notification information is information that prompts the user of the wireless terminal to turn ON the wireless LAN communication function of the wireless terminal, and is, for example, information notifying that detailed information is to be notified from the wireless LAN access point to the wireless terminal if the wireless LAN communication function is turned ON in the wireless terminal. This can motivate the user of the wireless terminal to turn ON the wireless LAN communication function of the wireless terminal.

Note that the notification information is, for example, information corresponding to an installation location of a wireless LAN access point, and for example, when the installation location of the wireless LAN access point is a restaurant, the user of the wireless terminal can acquire information related to the restaurant by turning ON the wireless LAN communication function of the wireless terminal.

2. Information Providing Method

Next, an example of an information providing method by the information providing system will be described. FIG. 1B is an explanatory diagram of an information providing method according to an embodiment.

As illustrated in FIG. 1B, a control unit of the wireless terminal transmits information including a current position acquired by the GPS unit (hereinafter, described as terminal position information) to the mobile phone base station with a predetermined period (step S1). The mobile phone base station transfers the terminal position information from the wireless terminal to the information providing apparatus (step S2).

The information providing apparatus stores the terminal position information transmitted from the wireless terminal through the mobile phone base station in a database (hereinafter, described as DB). Accordingly, the terminal position information is stored in the DB of the information providing apparatus with a predetermined period.

The information providing apparatus determines whether a wireless terminal exists in the communication area of the wireless LAN access point on the basis of the terminal position information stored in the DB (step S3). When having determined that a wireless terminal exists in the communication area of the wireless LAN access point, the information providing apparatus determines whether the wireless terminal is performing communication with the wireless LAN access point (step S4).

Then, when having determined that the wireless terminal existing in the communication area of the wireless LAN access point is not performing communication with the wireless LAN access point, the information providing apparatus transmits the notification information to the mobile phone base station addressing the wireless terminal (step S5). When having received the notification information addressing the wireless terminal from the information providing apparatus, the mobile phone base station transfers the notification information to the wireless terminal (step S6).

The control unit of the wireless terminal that has received the notification information displays the notification information in the display unit of the wireless terminal (step S7). Following that, when the user of the wireless terminal operates an operation unit of the wireless terminal to turn ON the wireless LAN communication function of the wireless terminal (step S8), a wireless signal is transmitted from the wireless LAN communication unit of the wireless terminal to the wireless LAN access point (step S9).

When having received the wireless signal transmitted from the wireless terminal, the wireless LAN access point transmits/receives a wireless signal to/from the wireless terminal to establish a session with the wireless terminal, and enters a communication state with the wireless terminal. This enables the wireless terminal to enter a communication-enabled state with the information providing apparatus through the wireless LAN access point. When the wireless terminal enters the communication-enabled state with the information providing apparatus, the wireless LAN access point transmits connection notification including information of the wireless terminal to the information providing apparatus (step S10).

When having received the connection notification from the wireless LAN access point, the information providing apparatus reads out information related to the installation location of the wireless LAN access point (hereinafter, may be described as location information) from the DB (step S11). The information providing apparatus then transmits the location information reads out from the DB to the wireless LAN access point as information addressing the wireless terminal (step S12). The wireless LAN access point transfers the received location information to the wireless terminal (step S13). The control unit of the wireless terminal displays the location information in the display unit of the wireless terminal (step S14).

As described above, the information providing method by the information providing system according to the embodiment can notify the wireless terminal of the notification information even if the wireless LAN function is in an OFF state in the wireless terminal. This motivates the user of the wireless terminal to turn ON the wireless LAN communication function of the wireless terminal, and can facilitate provision of the information from the wireless LAN access point to the wireless terminal.

3. Configuration of Information Providing System

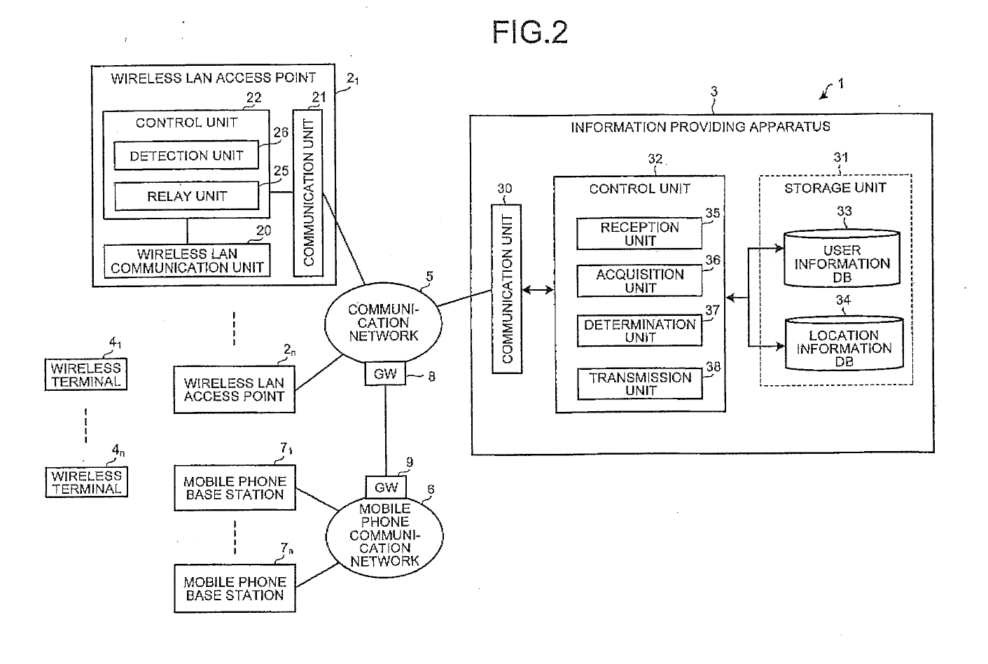

A specific configuration example of the information providing system according to the embodiment will be described with reference to FIG. 2. FIG. 2 is a diagram illustrating a specific configuration example of the information providing system according to the embodiment.

As illustrated in FIG. 2, an information providing system 1 includes a plurality of wireless LAN access points 2₁ to 2ₙ and an information providing apparatus 3, and provides wireless terminals 4₁ to 4ₙ with various types of information. The wireless terminals 4₁ to 4ₙ are mobile phone apparatuses including a wireless LAN communication function, like a smart phone, and are owned by users. Note that, when it is not necessary to distinguish the wireless terminals 4₁ to 4ₙ, the wireless terminal 4₁ to 4ₙ are collectively written as “wireless terminal 4”.

The wireless LAN access points 2₁ to 2ₙ and the information providing apparatus 3 are managed by, for example, an information providing service provider. Note that, when it is not necessary to distinguish the wireless LAN access points 2₁ to 2ₙ, the wireless LAN access points 2₁ to 2ₙ are collectively written as “wireless LAN access point 2”.

The wireless LAN access point 2 is connected with the information providing apparatus 3 through a communication network 5, and the information providing apparatus 3 can provide the wireless terminal 4 with various types of information from the wireless LAN access point 2 through the communication network 5. In the present embodiment, description will be given in which the communication network 5 is the Internet. However, the communication network 5 is not limited to the Internet, and may be a network exclusively provided for the information providing service provider, for example.

Further, a mobile phone communication network 6 is connected to the communication network 5 through gateway servers 8 and 9, and the information providing apparatus 3 can cause mobile phone base stations 7₁ to 7ₐ connected to the mobile phone communication network 6 to transmit information to the wireless terminal 4 through the communication network 5. Note that, when it is not necessary to distinguish the mobile phone base stations 71 to 7ₙ, the mobile phone base stations 7₁ to 7ₙ are collectively written as “mobile phone base station 7”.

Here, the mobile phone communication network 6 has been exemplarily described as the communication network to which the wireless WAN base station is connected. However, the communication network to which the wireless WAN base station is connected is not limited to the mobile phone communication network 6. For example, the communication network to which the wireless WAN base station is connected may be a data communication private network. In this case, the wireless WAN base station is a wireless base station of the data communication private network, and information is transmitted from the wireless base station to the wireless terminal 4.

The wireless terminal 4 includes a GPS unit, and every time receiving a signal from a GPS satellite by the GPS unit, the wireless terminal 4 calculates a current position on the basis of the received signal, and transmits terminal position information including information of the current position to the information providing apparatus 3 through the mobile phone base station with a predetermined period.

Further, the wireless terminal 4 includes a function to display the notification information in the display unit, and acquires and displays the notification information provided from the information providing system 1 through the communication network 5. Note that the function to display the notification information is, for example, a function included in an operating system (OS) of the wireless terminal 4 or an application.

Further, the wireless terminal 4 is equipped with a browser, and displays information of a page provided from the information providing system 1 or from a site (not illustrated). For example, when the communication network 5 is the Internet, the page provided from the information providing system 1 is a web page specified by a markup language such as a HyperText Markup Language (HTML).

Hereinafter, specific configurations of the wireless LAN access point 2 and of the information providing apparatus 3 will be described in that order.

4. Configuration of Wireless LAN Access Point 2

First, a configuration of the wireless LAN access point 2 will be specifically described. As illustrated in FIG. 2, the wireless LAN access point 2 includes a wireless LAN communication unit 20, a communication unit 21, and a control unit 22.

The wireless LAN communication unit 20 is installed such that an area including a location that is to be an object to be installed of the wireless LAN access point 2 can be the communication area. The wireless LAN communication unit 20 is a communication interface that performs wireless LAN communication, and transmits/receives information by wireless signals to/from the wireless terminal 4 equipped with the wireless LAN communication function. Note that an example of the wireless LAN includes a wireless LAN specified by IEEE802.11. However, the wireless LAN is not limited to the wireless LAN of the standard.

The communication unit 21 is connected to the communication network 5, and transmits/receives information to/from a communication network-side device through the communication network 5. The communication unit 21 is connected to the communication network 5 in a wired or wireless manner. The communication network-side device is, for example, the information providing apparatus 3 or a web server (not illustrated).

The control unit 22 includes a relay unit 25 that performs information relay processing and a detection unit 26 that performs detection processing of detecting the wireless terminal 4, and realizes or executes a function or an action of the information processing described below. Note that the internal configuration of the control unit 22 is not limited to the configuration, and may be another configuration as long as the configuration performs the information processing described below.

The relay unit 25 transmits information acquired from the wireless terminal 4 through the wireless LAN communication unit 20 to the communication network-side device from the communication unit 21, and transmits information acquired from the communication network-side device through the communication unit 21 to the wireless terminal 4 from the wireless LAN communication unit 20.

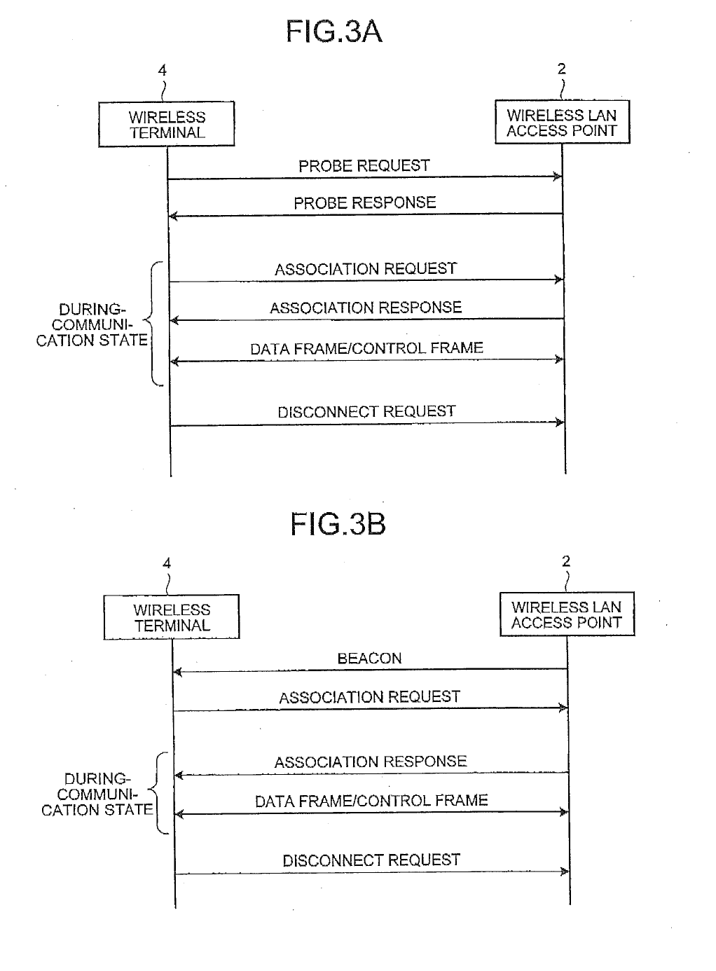

The detection unit 26 acquires a wireless packet transmitted from the wireless terminal 4 through the wireless LAN communication unit 20 to detect existence of the wireless terminal 4. FIGS. 3A and 3B are diagrams illustrating sequences of establishing a session between the wireless LAN access point 2 and the wireless terminal 4.

In the example illustrated in FIG. 3A, a wireless packet called probe request is periodically transmitted from the wireless terminal 4 by broadcast or the like, and the detection unit 26 acquires the wireless packet through the wireless LAN communication unit 20 to detect the existence of the wireless terminal 4.

The probe request includes a basic service set identifier (BSSID), and when the BSSID coincides with a BSSID of the wireless LAN communication unit 20, the detection unit 26 transmits a probe response to the wireless terminal 4. The wireless terminal 4 that has received the probe response transfers to a during-communication state in a case where automatic communication is set.

The transfer to the during-communication state is, as illustrated in FIG. 3A, performed by establishment of a session by an association request and an association response, and following that, the wireless terminal 4 and the wireless LAN communication unit 20 transmit/receive a data frame and a control frame each other to enter the during-communication state.

Further, the detection unit 26 broadcasts a wireless packet called beacon to the wireless terminal 4 to which the wireless packet is not periodically transmitted, through the wireless LAN communication unit 20 as illustrated in FIG. 3B, and receives an association request with respect to the beacon to detect the existence of the wireless terminal 4. The detection unit 26 that has received the association request transmits an association response to the wireless terminal 4 to establish a session, and causes the wireless terminal 4 and the wireless LAN communication unit 20 to be in the during-communication state.

When the detection unit 26 transfers to the during-communication state, the detection unit 26 repeatedly receives a wireless packet and detects the existence of the wireless terminal 4 until the during-communication state is cancelled. Note that the during-communication state is cancelled when a disconnect request is given from the wireless terminal 4 or when the wireless packet cannot be transmitted/received between the wireless terminal 4 and the wireless LAN communication unit 20.

When having determined to have detected the wireless terminal 4, for example, the detection unit 26 transmits detection information including the terminal information of the wireless terminal 4 from the communication unit 21 to the information providing apparatus 3. To be specific, the detection unit 26 extracts a terminal ID included in the wireless packet transmitted from the wireless terminal 4, and detects radio wave intensity.

The terminal ID is, for example, a MAC address of the wireless LAN communication unit of the wireless terminal 4, and is added to the wireless packet and transmitted from the wireless terminal 4. The radio wave intensity is radio wave intensity of a wireless signal received by the wireless LAN access point 2. Note that the radio wave intensity may be a received signal strength indication (RSSI) acquired in the wireless terminal 4. In this case, the wireless signal including information of the radio wave intensity is transmitted from the wireless terminal 4 to the wireless LAN access point 2.

The detection unit 26 transmits an AP-ID and information of whether being in the-during communication state in addition to the terminal ID of the wireless terminal 4 and information of the radio wave intensity to the information providing apparatus 3 as the detection information. As the AP-ID, for example, a network address (for example, an IP address) of the communication network 5 to be allocated to the communication unit 21 can be used.

5. Configuration of Information Providing Apparatus 3

Next, a specific configuration of the information providing apparatus 3 according to the embodiment will be described. As illustrated in FIG. 2, the information providing apparatus 3 includes a communication unit 30, a storage unit 31, and a control unit 32. Further, the storage unit 31 includes a user information DB 33 and a location information DB 34, and the control unit 32 includes a reception unit 35, an acquisition unit 36, a determination unit 37, and a transmission unit 38.

The communication unit 30 is an interface such as a network interface card (NIC). The control unit 32 transmits/receives various types of information to/from the wireless LAN access point 2, or the wireless terminal 4 through the wireless LAN access point 2, through the communication unit 30 and the communication network 5.

The user information DB 33 and the location information DB 34 are storage devices such as a hard disk, a random access memory (RAM), a semiconductor memory device such as a flash memory, or an optical disk. Note that the user information DB 33 and the location information DB 34 may be a single DB. Note that the various IDs stored in the user information DB 33 and the location information DB 34 are described using the reference signs “A1” and “U1”. These reference signs are denoted in order to distinguish the IDs for convenience of description, and are not given for the purpose of limiting the IDs.

The control unit 32 is realized, for example, by an integrated circuit such as an application specific integrated circuit (ASIC) or a field programmable gate array (FPGA). Further, the control unit 32 functions as the reception unit 35, the acquisition unit 36, the determination unit 37, and the transmission unit 38 by a program stored in the internal storage device being executed by a central processing unit (CPU) or a micro processing unit (MPU) using a RAM as a work area. Note that the configuration of the control unit 32 is not limited to the configuration, and may be another configuration as long as the configuration performs information processing described below.

5.1. Reception Unit 35

The reception unit 35 receives the detection information transmitted from the wireless LAN access point 2 or various requests transmitted from the wireless terminal 4 through the wireless LAN access point 2.

When having received the detection information transmitted from the wireless LAN access point 2, the reception unit 35 updates an AP terminal information table of the location information DB 34 on the basis of the terminal information, the AP-ID, and the information of whether being in the during-communication state included in the detection information.

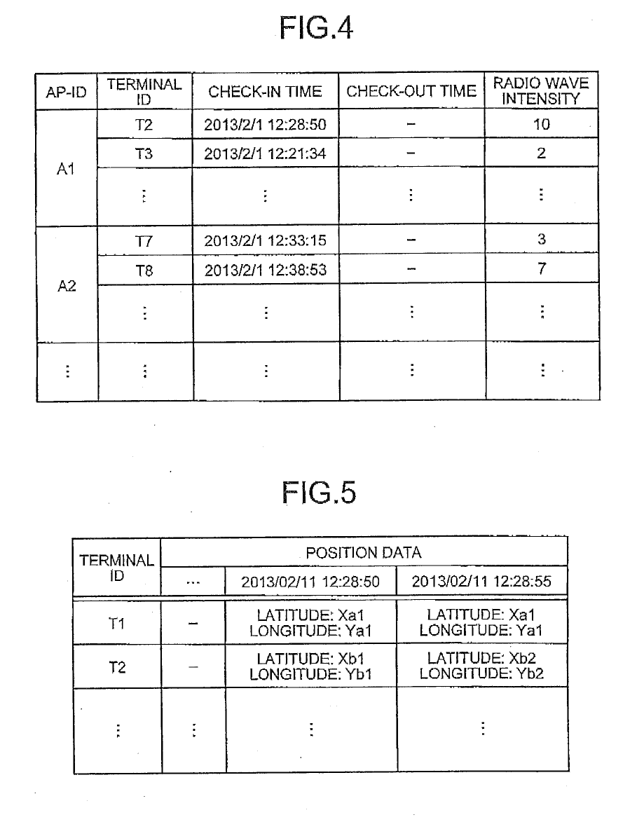

FIG. 4 is a drawing illustrating an example of the AP terminal information table stored in the location information DB 34. As illustrated in FIG. 4, the AP terminal information table is information in which a “terminal ID”, a “check-in time”, a “check-out time” and “radio wave intensity” are associated with each other for each “AP-ID”.

The “AP-ID” is identification information of the wireless LAN access point 2, and is information allocated to each wireless LAN access point 2.

The “terminal ID” is a terminal ID of the wireless terminal 4 existing in the communication area of the associated wireless LAN access point 2 (hereinafter, may be described as AP communication area). For example, the example of FIG. 4 illustrates the wireless terminals 4 of terminal IDS “T2” and “T3” exist in the communication area of the wireless LAN access point 2 of an AP-ID “A1”.

The “radio wave intensity” is information of the radio wave intensity of the wireless terminal 4 existing in the AP communication area. The example in FIG. 4 illustrates information of latest radio wave intensity corresponding to each terminal ID, for the purpose of convenience, and the information of radio wave intensity and an average value thereof from when the wireless terminal 4 entered the AP communication area are set to the terminal existence data. Further, the example of FIG. 4 illustrates the radio wave intensity by an intensity level in which the stronger the intensity, the larger the value within a range of 0 to 10. However, the radio wave intensity can be set by other units (for example, dBm).

When having received the detection information including the information of being in the during-communication state from the wireless LAN access point 2, the reception unit 35 sets the terminal ID and the information of the radio wave intensity included in the detection information to the terminal existence data in association with the “AP-ID” included in the detection information. Further, the reception unit 35 sets a time, at which the wireless terminal 4 has entered the during-communication state, to the terminal existence data as a “check-in time”.

A stay time of the wireless terminal 4 in the AP communication area can be detected by comparison of the check-in time and a current time. Note that the reception unit 35 can set a time, at which reception of the detection information is started, to the terminal existence data as an “enter time” regardless of whether being in the during-communication state.

When the wireless terminal 4, the information of which has been set to the terminal existence data, exits from the AP communication area afterwards, after setting the exit time of the wireless terminal 4 to the terminal existence data as a “check-out time”, the reception unit 35 deletes the information of the wireless terminal 4 that has exited from the AP terminal information table and manages the information as history information.

5.2. Acquisition Unit 36

The acquisition unit 36 acquires the terminal position information from the wireless terminal 4 through the mobile phone base station 7, and identifies a current position of the wireless terminal 4 from the terminal position information. The acquisition unit 36 sets information of the identified current position of the wireless terminal 4 to the terminal position information table.

FIG. 5 is a diagram illustrating an example of the terminal position information table stored in the location information DB 34. As illustrated in FIG. 5, the terminal position information table is information in which “position data” of each time is associated with each “terminal ID”.

The “terminal ID” is information unique to the wireless terminal 4, and is, for example, a MAC address of the wireless LAN communication unit of the wireless terminal 4. The terminal ID is added to the terminal position information and is transmitted from the wireless terminal 4. Note that the terminal ID may just be information unique to the wireless terminal 4 or information unique to the user of the wireless terminal 4, and may be, for example, an ID set by the user.

The “position data” is information indicating the position of the wireless terminal 4, and includes information of the latitude and the longitude. The position data is information of a current position included in the terminal position information, is transmitted from the wireless terminal 4 with a predetermined period, and is set to the terminal position information table by the acquisition unit 36 every time. For example, in the example illustrated in FIG. 5, as the position data of terminal IDs “T1” and “T2”, position data of every five seconds such as the position data of “12:28:50 on Feb. 11, 2013” and the position data of “12:28:55 on Feb. 11, 2013” are set.

Note that the acquisition unit 36 can acquire the position data of the wireless terminal 4 from a communication center (not illustrated) of the mobile phone communication network 6. The communication center of the mobile phone communication network 6 detects a position of the wireless terminal 4 by three-point measuring method based on the radio wave intensity of the wireless terminal 4 received by three mobile phone base stations 7, for example, and transmits a detection result to the wireless terminal 4 as the terminal position information.

In this case, the acquisition unit 36 of the wireless terminal 4 can set the terminal position information transmitted from the communication center of the mobile phone communication network 6 to the terminal position information table. Accordingly, the position information of the wireless terminal 4 not including a GPS unit can be acquired.

Further, the acquisition unit 36 can acquire the position information of the wireless terminal 4 on the basis of the detection information transmitted from the wireless LAN access point 2. For example, the wireless terminal 4 of the terminal ID “T2” illustrated in FIG. 4 exists in the AP communication area corresponding to the AP-ID “A1”, and the acquisition unit 36 can set the position information of the AP communication area corresponding to the AP-ID “A1” to the terminal position information table.

Further, the acquisition unit 36 can acquire the information of the wireless terminal 4 from various apparatuses installed in the AP communication area. The apparatus installed in the AP communication area is, for example, a short-distance communication apparatus that performs communication with the wireless terminal 4, and examples include a reading apparatus of Felica installed in a store and an automatic ticket gate installed in a station.

The short-distance communication apparatus acquires the identification information of the wireless terminal 4, and transmits the identification information (for example, terminal ID) of the wireless terminal 4 to the information providing apparatus 3 together with identification information of own apparatus. In this case, the information providing apparatus 3 stores, for example, the AP-ID and the identification information of the short-distance communication apparatus in the AP location information table in association with each other in advance in the storage unit 31. The acquisition unit 36 determines the AP communication area of the wireless terminal 4 from the identification information of the short-distance communication apparatus on the basis of the AP location information table, and acquires the position of the AP communication area as the position information of the wireless terminal 4.

Note that the short-distance communication apparatus is an apparatus that employs a communication system such as Felica, ISO/IEC14443 (MIFARE), or Bluetooth (registered trademark). Communication by the short-distance communication apparatus is not limited to by a radio wave, and may use, for example, infrared communication, visible light communication, or a sound wave.

Further, an example of the apparatus installed in the AP communication area includes a position information providing apparatus that transmits the position information to the wireless terminal 4. The position information providing apparatus may be a short-distance communication apparatus that wirelessly provides information of the position where the own apparatus is installed, or may be a medium that provides a barcode or the like including the position information. The wireless terminal 4 acquires the position information from the position information providing apparatus by wireless communication or a camera, and transmits the acquired position information to the information providing apparatus 3 through the mobile phone base station 7 as the terminal position information. This enables even the wireless terminal 4 not including a GPS unit to transmit the terminal position information to the information providing apparatus 3.

Note that the position information of each AP communication area is set to the AP location information table described below, and the acquisition unit 36 can acquire the position information of the AP communication area from the AP location information table. Further, the position information of the AP communication area may be included in the detection information transmitted from the wireless LAN access point 2. In this case, the acquisition unit 36 can acquire the position information of the AP communication area from the detection information transmitted from the wireless LAN access point 2.

5.3. Determination Unit 37

The determination unit 37 determines whether the wireless terminal 4 is positioned in the AP communication area on the basis of the terminal position information acquired by the acquisition unit 36. To be specific, the determination unit 37 determines whether the wireless terminal 4, the position data of which has been set to the terminal position information table, is positioned in the latitude and the longitude of the AP communication area set to the AP location information table.

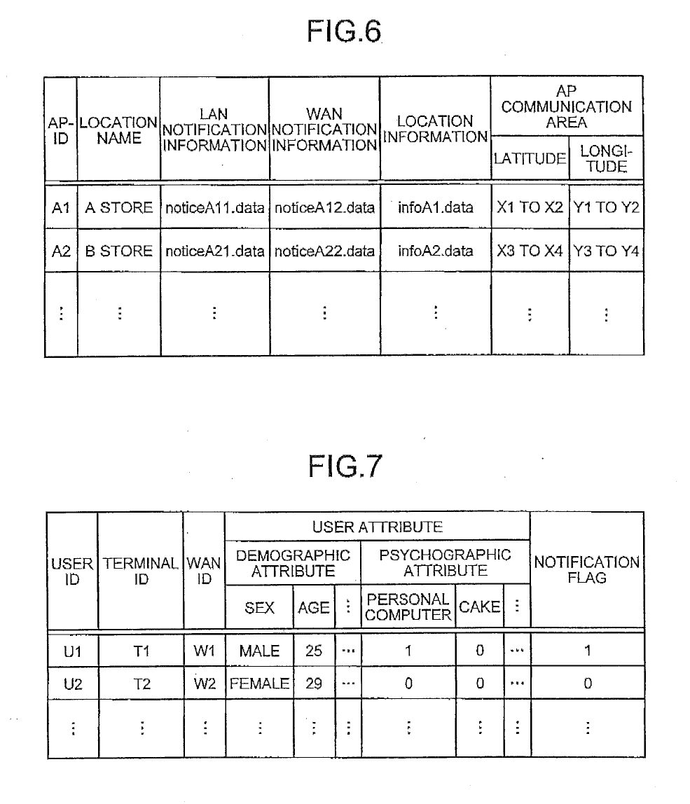

FIG. 6 is a diagram illustrating an example of the AP location information table stored in the location information DB 34. As illustrated in FIG. 6, the AP location information table is information in which a “location name”, “LAN notification information”, “WAN notification information”, “location information” and an “AP communication area” are associated with each other for each “AP-ID”.

The “AP-ID” is identification information of the wireless LAN access point 2 and is information allocated to each wireless LAN access point 2, and is, for example, an IP address as described above. The “location name” is a name of the installation location of the wireless LAN access point 2, and for example, the installation location of the wireless LAN access point 2 of the AP-ID “A1” is the “A store”.

The “LAN notification information” is information indicating a file name of the notification information to be notified to the wireless terminal 4 through the wireless LAN access point 2, and is stored in the location information DB 34. Further, the “WAN notification information” is information indicating a file name of the notification information to be notified to the wireless terminal 4 through the mobile phone base station 7, and is stored in the location information DB 34.

In the AP location information table illustrated in FIG. 6, for example, the “LAN notification information” of the AP-ID “A1” is a file name “noticeA11.data”, and the “WAN notification information” is a file name “noticeA21.data”.

The “location information” is information related to the installation location of the wireless LAN access point 2, and to which information of a store portal site, and the like are set, for example. The “AP communication area” is information indicating the latitude and the longitude of the communication area of the wireless LAN access point 2. For example, in the AP location information table illustrated in FIG. 6, the wireless LAN access point 2 of the AP-ID “A1” indicates the AP communication area in a range of the latitude of X1 to X2 and the longitude of Y1 to Y2.

For example, assume that the terminal position information table and the AP location information table are in a state illustrated in FIGS. 5 and 6. In this case, if Xa1 is not in the range of X1 to X2, or Ya1 is not in the range of Y1 to Y2, the determination unit 37 determines that the wireless terminal 4 of the terminal ID “T1” does not exist in the communication area of the wireless LAN access point 2 of the AP-ID “A1”.

Meanwhile, if the Xa1 is in the range of X1 to X2, and the Ya1 is in the range of Y1 to Y2, the determination unit 37 determines that the wireless terminal 4 of the terminal ID “T1” exists in the communication area of the wireless LAN access point 2 of the AP-ID “A1”. When having determined that the wireless terminal 4 set to the terminal position information table exists in the AP communication area set to the AP location information table, the determination unit 37 determines whether the wireless terminal 4 is performing communication with the wireless LAN access point 2 on the basis of the AP terminal information table.

For example, assume that the AP terminal information table is in a state illustrated in FIG. 4, and the wireless terminal 4 of the terminal ID “T1” exists in the AP communication area corresponding to the AP-ID “A1”. In this case, since the information of the wireless terminal 4 of the terminal ID “T1” is not set corresponding to the AP-ID “A1” in the AP terminal information table, the determination unit 37 determines that the wireless terminal 4 of the terminal ID “T1” is not performing communication with the wireless LAN access point 2 of the AP-ID “A1”.

5.4. Transmission Unit 38

The transmission unit 38 transmits WAN notification information to the wireless terminal 4 positioned in the AP communication area and determined not to be performing communication with the wireless LAN access point 2 (hereinafter, may be described as in-AP non-communication terminal) on the basis of a determination result of the determination unit 37.

For example, assume that the wireless terminal 4 of the terminal ID “T1” is positioned in the AP communication area corresponding to the AP-ID “A1”, and is not performing communication with the wireless LAN access point 2 of the AP-ID “A1”. In this case, the transmission unit 38 acquires the WAN notification information corresponding to the AP-ID “A1” from the AP location information table, and transmits the WAN notification information to the wireless terminal 4 of the terminal ID “T1” through the mobile phone base station 7.

A WAN-ID that is a destination of the wireless terminal 4 in the mobile phone communication network 6 is set in the user information table, and the transmission unit 38 acquires the WAN-ID of the wireless terminal 4 that is an object to be transmitted of the WAN notification information from the user information table.

FIG. 7 is an example of the user information table stored in the user information DB 33. As illustrated in FIG. 7, the user information table includes information in which information of a “terminal ID”, a “WAN-ID”, a “user attribute”, and a “notification flag” are associated with each other for each “user ID”. The “terminal ID”, the “WAN-ID”, the “user attribute”, and the “notification flag” are, for example, information included in a registration request or the like from the wireless terminal 4 to the information providing apparatus 3, and is set to the user information table by the reception unit 35 when the wireless terminal 4 performs user registration or a registration change with respect to the information providing apparatus 3.

The user registration can be performed, for example, by the wireless terminal 4 with respect to the information providing apparatus 3 through the mobile phone communication network 6. In this case, the reception unit 35 of the information providing apparatus 3 allocates a user ID to a request of the user registration transmitted from the wireless terminal 4, and sets the information such as the terminal ID, the WAN-ID, and the user attribute included in the request of the user registration to the user information table.

The “user ID” is an ID allocated to each user of the wireless terminal 4, and is, for example, set to the user information table by the reception unit 35 when the wireless terminal 4 performs the user registration to the information providing apparatus 3.

The “terminal ID” is information similar to the “terminal ID” set to the terminal position information table. Note that the terminal ID may just be one capable of identifying the wireless terminal 4, and is not necessarily limited to a MAC address.

The “WAN-ID” is identification information of the wireless terminal 4 at the mobile phone communication unit side. For example, when the wireless terminal 4 is a third generation mobile communication system, the WAN-ID is a unique number of a subscriber identity module card (SIM card) incorporated in the wireless terminal 4. The unique number is also called international mobile subscriber identity (IMSI). The wireless terminal 4 transmits/receives a wireless packet including the WAN-ID to/from the mobile phone base station 7 to perform communication with the mobile phone base station 7.

The user attribute is user attribute information of the user of the wireless terminal 4. The user attribute includes a demographic attribute and a psychographic attribute. The demographic attribute includes, for example, attributes such as sex and age of the user. To the psychographic attribute, attributes indicating liking of the user such as personal computer and cake are set, for example, and “1” is set to the attribute in which the user has an interest, and “0” is set to other attributes.

The user attribute is, for example, set to the user information table by the reception unit 35 when the wireless terminal 4 performs the user registration or the registration change with respect to the information providing apparatus 3. Note that the user attributes illustrated in FIG. 7 are an example, and various attributes can be set to the user information table.

The “notification flag” is a flag of whether notifying the WAN notification information, and the wireless terminal 4 in which the notification flag is “1” is an object to be notified of the WAN notification information, and the wireless terminal 4 in which the notification flag is “0” is an object not to be notified of the WAN notification information. For example, even when the wireless terminal 4 of the terminal ID “T2” illustrated in FIG. 7 is positioned in the AP communication area corresponding to the AP-ID “A1”, and is not performing communication with the wireless LAN access point 2 of the AP-ID “A1”, the transmission unit 38 does not transmit the WAN notification information to the wireless terminal 4 of the terminal ID “T2”.

Note that, in the example of the user information table illustrated in FIG. 7, the “notification flag” is set. However, a “notification level” can be set, for example. The “notification level” is information for changing an object to be notified of the WAN notification information in stages, and is set from a level 0 to a level 3, for example.

When the notification level is the “level 0”, the transmission unit 38 performs similar processing to the case in which the notification flag is “0”, and when the notification level is the “level 3”, the transmission unit 38 performs a similar processing to the case in which the notification flag is “1”. Meanwhile, when the notification level is the “level 1” or the “level 2”, the transmission unit 38 determines whether the wireless terminal 4 is to be an object to be notified of the WAN notification information according to the position or a stay time of the wireless terminal 4.

When the notification level is the “level 1”, for example, the transmission unit 38 determines the wireless terminal 4 staying at a position within a predetermined range close to a center of the AP communication area for a predetermined time or more to be the object to be notified of the WAN notification information, for example. Note that the transmission unit 38 determines whether the wireless terminal 4 is positioned within a predetermined range by the radio wave intensity of the wireless terminal 4, for example.

When the notification level is the “level 2”, for example, the transmission unit 38 determines the wireless terminal 4 staying in the AP communication area for a predetermined time to be the object to be notified of the WAN notification information. Note that, when the notification level is the “level 3”, the wireless terminal 4 staying in the AP communication area for a predetermined time or more is determined to be the object to be notified of the WAN notification information. However, the “predetermined time” is shorter than the cases of the “level 1” and the “level 2”.

Further, whether the wireless terminal 4 is to be the object to be notified of the WAN notification information can be determined according to the user attribute. For example, when the notification level is the “level 1”, the wireless terminal 4 is determined to be the object to be notified of the WAN notification information only when the user of the wireless terminal 4 staying at a position within a predetermined range close to a center of the AP communication area for a predetermined time or more has a predetermined user attribute. Further, when the notification level is the “level 2”, the wireless terminal 4 is determined to be the object to be notified of the WAN notification information only when the user of the wireless terminal 4 staying in the AP communication area for a predetermined time or more has a predetermined user attribute.

As described above, the object to be notified of the WAN notification information can be set according to the stay time in the AP communication area of the wireless terminal 4, the position of the wireless terminal 4, the user attribute of the user of the wireless terminal 4, and the like, as the notification level. Accordingly, the WAN notification information can be more appropriately notified to the user of the wireless terminal 4. Note that the above-described notification levels are an example, and various notification levels can be set by combinations of the stay time in the AP communication area of the wireless terminal 4, the position of the wireless terminal 4, the user attribute of the user of the wireless terminal 4, and the like.

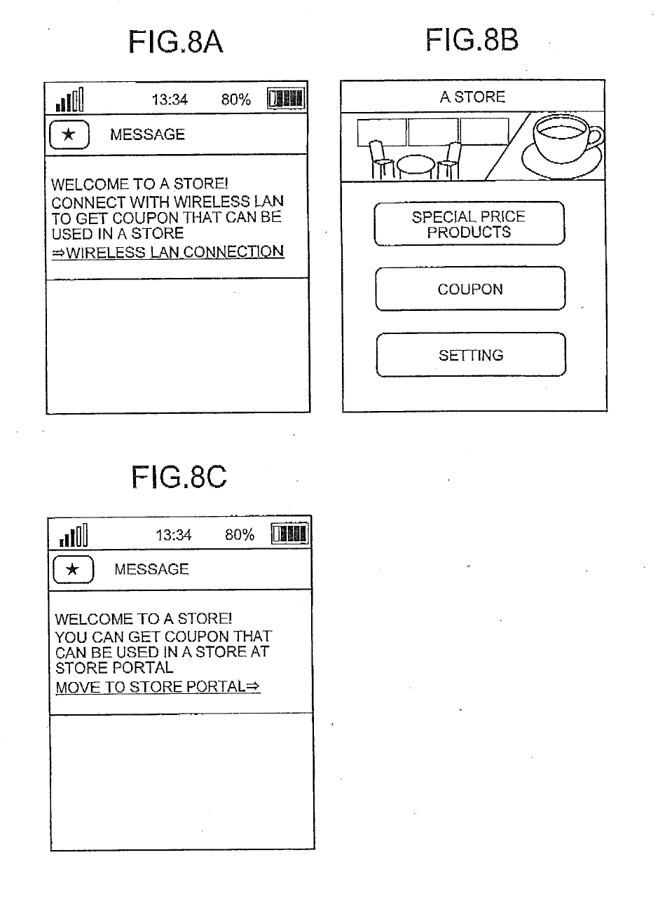

When having received the WAN notification information from the information providing apparatus 3, the control unit of the wireless terminal 4 displays a screen according to the WAN notification information in the display unit of the wireless terminal 4. The WAN notification information is, for example, information prompting the user of the wireless terminal 4 to turn ON the wireless LAN communication function of the wireless terminal 4, and is displayed in the display unit of the wireless terminal 4 as illustrated in FIG. 8A. FIG. 8A is a diagram illustrating a screen example that displays the WAN notification information in the display unit of the wireless terminal 4.

In the screen illustrated in FIG. 8A, when the user of the wireless terminal 4 selects “wireless LAN connection” on the screen by an operation of the operation unit, for example, the control unit of the wireless terminal 4 establishes communication with the wireless LAN access point 2, and transfers to a communication state with the wireless LAN access point 2. The transmission unit 38 acquires information corresponding to the installation location of the wireless LAN access point 2 from the AP location information table and transmits the information to the wireless terminal 4 that has established the communication with the wireless LAN access point 2 after notified the WAN notification information. This enables the user of the wireless terminal 4 to easily acquire the information corresponding to the installation location of the wireless LAN access point 2.

FIG. 8B is a diagram illustrating a screen example that displays the location information transmitted from the information providing apparatus 3 in the display unit of the wireless terminal 4. The location information is, for example, information of a store portal site for browsing digital content related to the installation location of the wireless LAN access point 2 and content such as a shopping page.

Further, the transmission unit 38 transmits the LAN notification information to the wireless terminal 4 that has entered the wireless LAN access point 2 in a state in which the wireless LAN communication function is ON, and is performing communication with the wireless LAN access point 2. Whether the wireless terminal 4 is the wireless terminal 4 that has entered the wireless LAN access point 2 and is performing communication with the wireless LAN access point 2 is determined by the determination unit 37 on the basis of the AP location information table.

For example, assume that the AP terminal information table is in a state illustrated in FIG. 4, and the wireless terminal 4 of the terminal ID “T2” exists in the AP communication area corresponding to the AP-ID “A1”. In this case, the information of the wireless terminal 4 of the terminal ID “T2” is set corresponding to the AP-ID “A1” in the AP terminal information table. Therefore, the determination unit 37 determines that the wireless terminal 4 of the terminal ID “T2” is performing communication with the wireless LAN access point 2 of the AP-ID “A1”.

The LAN notification information is, for example, information prompting an access to a store portal site, and is displayed in the display unit of the wireless terminal 4 as illustrated in FIG. 8C. FIG. 8C is a diagram illustrating a screen example that displays the LAN notification information through the wireless LAN access point 2 in the display unit of the wireless terminal 4.

Note that, when the wireless terminal 4 that is the object to be transmitted of the WAN notification information exists in the same AP communication area, the transmission unit 38 does not transmit the LAN notification information. Accordingly, notification of similar information to the wireless terminal 4 can be suppressed.

6. Processing Flow of Information Providing System 1

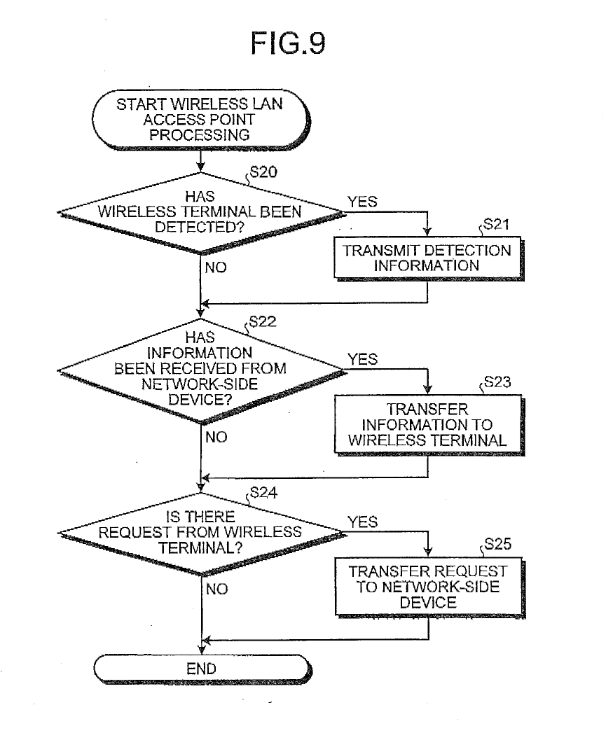

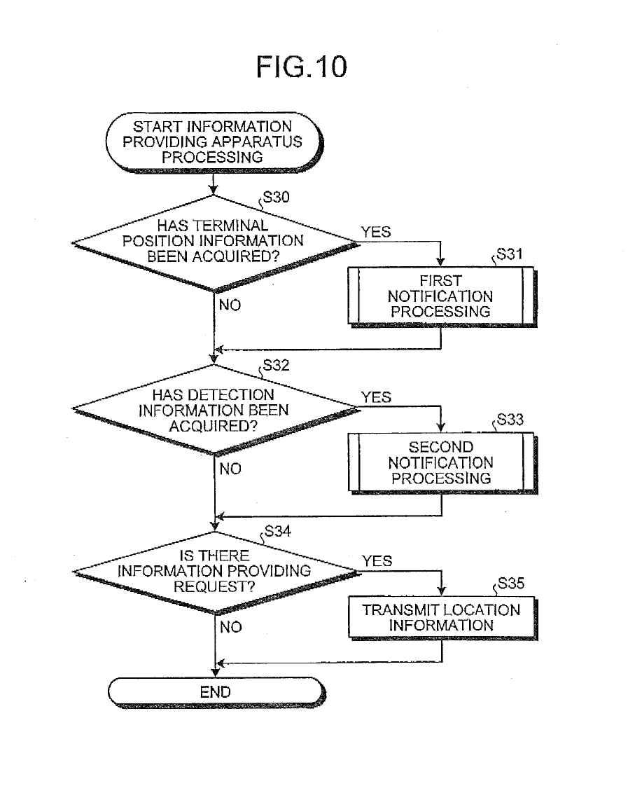

Next, a procedure of information providing process by the information providing system 1 according to the embodiment will be described. FIGS. 9 to 12 are diagrams for describing information providing process flows by the information providing system 1. Hereinafter, processing of the wireless LAN access point 2 will be described with reference to FIG. 9, and processing of the information providing apparatus 3 will be described with reference to FIGS. 10 to 12.

6.1. Processing Flow of Wireless LAN Access Point 2

First, information processing of the wireless LAN access point 2 according to the embodiment will be described with reference to FIG. 9. FIG. 9 is a flowchart of information processing at the wireless LAN access point 2. The operation is processing repeatedly executed by the control unit 22 of the wireless LAN access point 2.

As illustrated in FIG. 9, the control unit 22 of the wireless LAN access point 2 determines whether having detected the wireless terminal 4 through the wireless LAN communication unit 20 (step S20). In the processing, when having determined to have detected the wireless terminal 4 (Yes in step S20), the control unit 22 transmits the detection information including the terminal information, the AP-ID, the information of being in the during-communication state, and the like to the information providing apparatus 3 through the communication unit 21 (step S21).

In the processing of step S20, when having determined not to have detected the wireless terminal 4 (No in step S20), or when the processing of step S21 ends, the control unit 22 determines whether having received the information from the communication network-side device connected to the communication network 5 through the communication unit 21 (step S22). When having determined to have received the information from the communication network-side device (Yes in step S22), the control unit 22 transfers the received information to the wireless terminal 4 that is the destination of the information (step S23).

In step 322, when having determined not to have received the information (No in step S22), or the processing of step S23 ends, the control unit 22 determines whether there is a request from the wireless terminal 4 to the communication network-side device (step S24). When having determined that there is a request from the wireless terminal 4 to the communication network-side device (Yes in step S24), the control unit 22 transfers the request from the wireless terminal 4 to the communication network-side device to the communication network-side device through the communication unit 21 (step S25).

When the processing of step S25 ends, or when having determined that there is no request from the wireless terminal 4 to the communication network-side device in step S24 (No in step S24), the control unit 22 terminates the processing. The control unit 22 can respectively execute the processing of steps S20 and S21, the processing of steps S22 and 323, and the processing of steps S24 and S25 by multitask processing, for example.

6.2. Processing Flow of Information Providing Apparatus 3

Next, processing of the information providing apparatus 3 will be described. FIG. 10 is a flowchart of information processing in the information providing apparatus 3. The operation is processing repeatedly executed by the control unit 32 of the information providing apparatus 3.

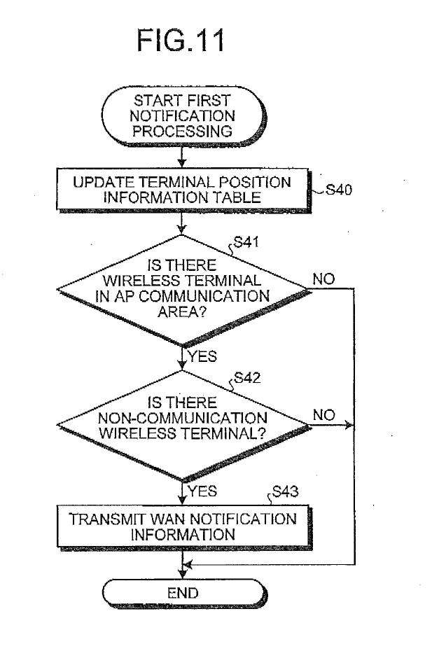

As illustrated in FIG. 10, the control unit 32 determines whether having acquired the terminal position information from the wireless terminal 4 through the communication unit 30 (step S30). When having determined to have acquired the terminal position information from the wireless terminal 4 (Yes in step S30), the control unit 32 performs first notification processing (step S31). The first notification processing is processing of steps S40 to 343 illustrated in FIG. 11, and will be described in detail below.

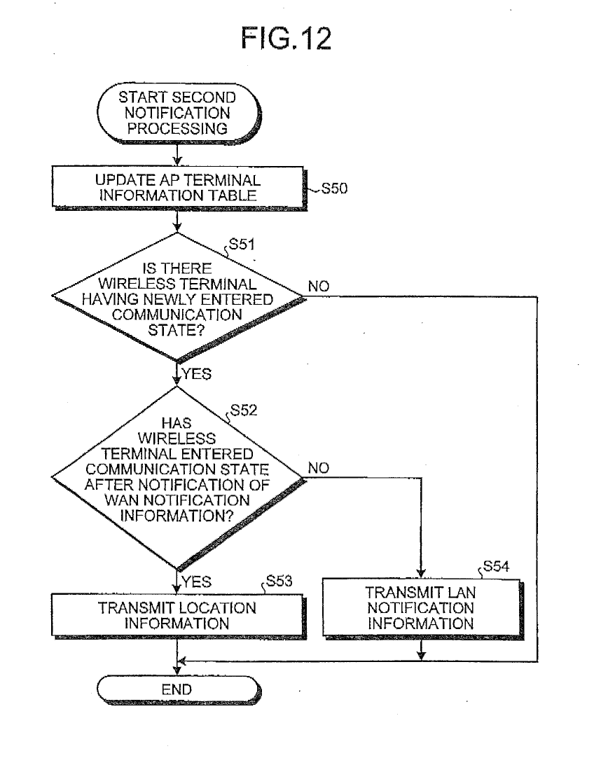

In step S30, when having determined not to have acquired the terminal position information from the wireless terminal 4 (No in step S30), or when the processing of step S31 ends, the control unit 32 determines whether having received the detection information from the wireless LAN access point 2 through the communication unit 30 (step S32). When having determined to have received the detection information (Yes in step S32), the control unit 32 performs second notification processing (step S33). The second notification processing is processing of steps S50 to S54 illustrated in FIG. 12, and will be described in detail below.

In step S32, when having not received the detection information (No in step S32), or when the processing of step S33 ends, the control unit 32 determines whether having received an information providing request from the wireless terminal 4 through the communication unit 30 (step S34). When having received the information providing request (Yes in step S34), the control unit 32 transmits the location information according to the information providing request to the wireless terminal 4 as the requestor (step S35).

In step 334, when having not received the information providing request (No in step S34), or the processing of step S35 ends, the control unit 32 terminates the processing.

Next, the first notification processing in step S31 illustrated in FIG. 10 will be described. FIG. 11 is a flowchart of the first notification processing in the information providing apparatus 3.

As illustrated in FIG. 11, in the first notification processing, the control unit 32 updates the terminal position information table on the basis of the acquired terminal position information (step S40).

Next, the control unit 32 determines whether there is a wireless terminal 4 positioned in the AP communication area on the basis of the updated terminal position information table (step S41). When having determined that there is a wireless terminal 4 positioned in the AP communication area (Yes in step S41), the control unit 32 determines whether there is a wireless terminal 4 that is not performing communication with the wireless LAN access point 2 among the wireless terminals 4 positioned in the AP communication area on the basis of the AP terminal information table (step S42).

When having determined that there is a wireless terminal 4 that is not performing communication with the wireless LAN access point 2 in step S42 (Yes in step S42), the control unit 32 transmits the WAN notification information to the wireless terminal 4 determined not to be performing communication with the wireless LAN access point 2 through the mobile phone base station 7 (step S43). Note that, when the control unit 32 transmits the same WAN notification information to the same wireless terminal 4, the transmission is subject to expiration of a predetermined time or more.

In step S41, when having determined that there is no wireless terminal 4 positioned in the AP communication area (No in step S41), when having determined that there is no wireless terminal 4 that is not performing communication with the wireless LAN access point 2 in step 342 (No in step S42), or when the processing of step S44 ends, the control unit 32 terminates the processing.

Next, the second notification processing illustrated in step S33 illustrated in FIG. 10 will be described. FIG. 12 is a flowchart of the second notification processing in the information providing apparatus 3.

As illustrated in FIG. 12, in the second notification processing, the control unit 32 updates the AP terminal information table on the basis of the received detection information (step S50).

Next, the control unit 32 determines whether there is a wireless terminal 4 that has newly entered a communication state with the wireless LAN access point 2 in the AP communication area on the basis of the updated AP terminal information table (step S51). When having determined that there is a wireless terminal 4 that has newly entered the communication state in the AP communication area (Yes in step S51), the control unit 32 determines whether the wireless terminal 4 that has newly entered the communication state is a wireless terminal 4 that has entered the communication state-after the transmission of the WAN notification information (step S52).

In step S52, when having determined that it is the wireless terminal 4 that has entered the communication state after the transmission of the WAN notification information (Yes in step S52), the control unit 32 acquires the location information corresponding to the AP communication area from the AP location information table, and transmits the location information to the wireless terminal 4 that has newly entered the communication state (step S53).

Meanwhile, when having determined that it is not the wireless terminal 4 that has entered the communication state after the transmission of the WAN notification information (No in step S52), the control unit 32 acquires the LAN notification information corresponding to the AP communication area from the AP location information table, and transmits the LAN notification information to the wireless terminal 4 that has newly entered the communication state (step S54).

When the processing of steps S53 and S54 ends, or when having determined that there is no wireless terminal 4 that has newly entered the communication state in the AP communication area in step S51 (No in step S51), the control unit 32 terminates the processing.

7. Modification

In the above embodiment, the description has been given in which the user attributes, the notification flag, and the notification level can be set to the user information table from the wireless terminal 4. However, other pieces of information can be set from the wireless terminal 4. For example, conditions of a period and a region where the notification of the WAN notification information is permitted can be set to the user information table from the wireless terminal 4. In this case, the control unit 32 transmits the WAN notification information to the wireless terminal 4 that satisfies the conditions of a region and a period set in the user information table.

Further, in the above-described embodiment, the “notification flag” and the “notification level” are set to the WAN notification information. However, the “notification flag” and the “notification level” can be set to the LAN notification information, and the setting can be performed from the wireless terminal 4.

Further, in the above-described embodiment, a plurality of terminal ID can be set to one user ID. In this case, the control unit 32 transmits the WAN notification information and the LAN notification information to the wireless terminal 4 corresponding to any one of the plurality of terminals ID. The control unit 32 can, for example, select the terminal ID of the wireless terminal 4 that has a high possibility of performing communication with the wireless LAN access point 2 after the notification of the WAN notification information. Whether it is the wireless terminal 4 that has a high possibility of performing communication with the wireless LAN access point 2 is, for example, determined from the history information stored in the user information DB 33.

Further, in the above-described embodiment, description has been given in which the control unit 32 of the wireless terminal 4 transmits the terminal position information to the information providing apparatus 3 with the predetermined period. However, the embodiment is not limited to the example. For example, an area to serve as an object to be transmitted of the terminal position information (hereinafter, described as area to be transmitted) is stored in the storage unit of the wireless terminal 4, and when the wireless terminal 4 is positioned in a range of the area to be transmitted, the control unit of the wireless terminal 4 can transmit the terminal position information to the information providing apparatus 3 with a predetermined period. Note that the area to be transmitted can be selected or set from the operation unit of the wireless terminal 4.

Note that, in the above-described embodiment, the function to transmit the detection information of the wireless terminal 4 is performed in each wireless LAN access point 2. However, the function to transmit the detection information of the wireless terminal 4 may be executed by a separately provided wireless LAN access point for detection. By separately providing the wireless LAN access point for detection, the above-described information providing service can be provided to a location where the wireless LAN access point has already been installed by installing the wireless LAN access point for detection.

8. Effects

As described above, in the information providing system 1 according to the embodiment, the location information DB 34 (an example of a notification information storage unit) stores notification information corresponding to the wireless LAN access point 2, the acquisition unit 36 (an example of a terminal position detection unit) acquires terminal position information including position information indicating the position of the wireless terminal 4, and the transmission unit 38 (an example of a notification unit) notifies the wireless terminal 4 positioned in the communication area of the wireless LAN access point 2 and not performing communication with the wireless LAN access point 2 of the notification information via the mobile phone base station 7 (an example of a wireless WAN base station).

With the configuration, even if the wireless LAN function is in the OFF state in the wireless terminal 4, the notification information can be notified to the wireless terminal 4, and a motivation to turn ON the wireless LAN communication function of the wireless terminal 4 can be given to the user of the wireless terminal 4. As a result, the information delivery from the wireless LAN access point 2 to the wireless terminal 4 can be facilitated.

Further, the determination unit 37 (an example of a position determination unit and a communication determination unit) determines whether the wireless terminal 4 is positioned in the communication area of the wireless LAN access point 2 on the basis of the terminal position information acquired by the acquisition unit 36, and further determines whether the wireless terminal 4 determined to be positioned in the communication area of the wireless LAN access point 2 is performing communication with the wireless LAN access point 2, and the transmission unit 38 notifies the wireless terminal 4, which has been determined not to be performing communication with the wireless LAN access point 2 by the determination unit 37, of the WAN notification information (an example of notification information).

With the configuration, the wireless terminal 4 positioned in the communication area of the wireless LAN access point 2, and not performing communication with the wireless LAN access point 2 can be easily detected, and the processing load in the information providing apparatus 3 can be reduced.

Further, the determination unit 37 determines a wireless terminal 4 continuously existing in a position corresponding to the communication area of the wireless LAN access point 2 for a predetermined time as the wireless terminal 4 positioned in the communication area of the wireless LAN access point 2.

With the configuration, for example, the notification information can be transmitted to the wireless terminal 4 of the user who is highly possibly staying in the installation location of the wireless LAN access point 2. Therefore, for example, notification of the notification information to the wireless terminal 4 of the user who passes through the communication area of the wireless LAN access point 2 after notified the notification information can be suppressed.

Further, the location information DB 34 (an example of an installation location information storage unit) stores the location information that is the information related to the installation location of the wireless LAN access point 2, the acquisition unit 36 acquires, when the wireless terminal 4 to which the WAN notification information has notified enters a communication state with the wireless LAN access point 2, the location information from the location information DB 34, and the transmission unit 38 (an example of a location information transmission unit) transmits the location information acquired by the acquisition unit 36 to the wireless terminal 4 that has entered the communication state with the wireless LAN access point 2 after the notification of the WAN notification information.

With the configuration, the user of the wireless terminal 4 to which the WAN notification information has been notified can acquire the information related to the installation location of the wireless LAN access point 2 by turning ON the wireless LAN communication function of the wireless terminal 4, and convenience can be improved.

9. Others

The above-described information providing apparatus 3 may be realized by a plurality of server computers, and the configuration can be flexibly changed depending on a function such as by being realized by calling an outside platform or the like by an application programming interface (API), network computing, or the like. Further, the wireless LAN access point 2 and the information providing apparatus 3 may be realized by a single server computer.

The information providing system, the information providing apparatus, and the information providing method according to the present application have effects of facilitating information providing from a wireless LAN communication unit to a wireless terminal.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information providing system comprising:
a wireless LAN communication unit;
a notification information storage unit configured to store notification information corresponding to the wireless LAN communication unit;
a terminal position acquisition unit configured to acquire position information indicating a position of a wireless terminal; and
a notification unit configured to notify a wireless terminal of the notification information via a wireless WAN base station, the wireless terminal being positioned in a communication area of the wireless LAN communication unit and being not performing communication with the wireless LAN communication unit.

2. The information providing system according to claim 1, comprising:
a position determination unit configured to determine whether the wireless terminal is positioned in the communication area of the wireless LAN communication unit on the basis of the position information acquired by the terminal position acquisition unit; and
a communication determination unit configured to determine whether the wireless terminal that is determined to be positioned in the communication area of the wireless LAN communication unit by the position determination unit is performing communication with the wireless LAN communication unit, wherein
the notification unit notifies the wireless terminal, which is determined not to be performing communication with the wireless LAN communication unit by the communication determination unit, of the notification information.

3. The information providing system according to claim 2, wherein
the position determination unit determines a wireless terminal continuously existing in a position corresponding to the communication area of the wireless LAN communication unit for a predetermined time as the wireless terminal positioned in the communication area of the wireless LAN communication unit.

4. The information providing system according to claim 1, comprising:
an installation location information storage unit configured to store information related to an installation location of the wireless LAN communication unit;
an installation location information acquisition unit configured to acquire information related to the installation location from the installation location information storage unit when the wireless terminal of which the notification information is notified enters a communication state with the wireless LAN communication unit; and
a location information transmission unit configured to transmit the information related to the installation location acquired by the installation location information acquisition unit to the wireless terminal that enters the communication state with the wireless LAN communication unit after the notification of the notification information.

5. An information providing apparatus comprising:
a notification information storage unit configured to store notification information corresponding to a wireless LAN communication unit;
a terminal position acquisition unit configured to acquire position information indicating a position of a wireless terminal; and
a notification unit configured to notify a wireless terminal of the notification information via a wireless WAN base station, the wireless terminal being positioned in a communication area of the wireless LAN communication unit and being not performing communication with the wireless LAN communication unit.

6. An providing information method executed by a computer that stores notification information corresponding to a wireless LAN communication unit, the method comprising:
(a) acquiring position information indicating a position of a wireless terminal; and
(b) notifying a wireless terminal of the notification information via a wireless WAN base station, the wireless terminal being positioned in a communication area of the wireless LAN communication unit and being not performing communication with the wireless LAN communication unit.

7. The information providing method according to claim 6, comprising:
(c) determining whether the wireless terminal is positioned in the communication area of the wireless LAN communication unit on the basis of the acquired position information in the (a) acquiring; and
(d) determining whether the wireless terminal that is determined to be positioned in the communication area of the wireless LAN communication unit in the (c) determining is performing communication with the wireless LAN communication unit, wherein
the (b) notifying includes notifying the wireless terminal, which is determined not to be performing communication with the wireless LAN communication unit in the (d) determining, of the notification information.

8. The information providing method according to claim 7, wherein
the (c) determining including determining a wireless terminal continuously existing in a position corresponding to the communication area of the wireless LAN communication unit for a predetermined time as the wireless terminal positioned in the communication area of the wireless LAN communication unit.

9. The information providing method according to claim 6, comprising:
(e) acquiring information related to the installation location from an installation location information storage unit when the wireless terminal of which the notification information is notified enters a communication state with the wireless LAN communication unit; and
(f) transmitting the information related to the acquired installation location in the (e) acquiring to the wireless terminal that communicates with the wireless LAN communication unit after the notification of the notification information.
